(19) United States
(12) Patent Application Publication
(10) Pub. No.: US 2022/0299341 A1
(43) Pub. Date: Sep. 22, 2022

(54) METHOD, APPARATUS, AND SYSTEM FOR PROVIDING ROUTE-IDENTIFICATION FOR UNORDERED LINE DATA

(71) Applicant: HERE Global B.V., Eindhoven (NL)

(72) Inventor: Zhenhua ZHANG, Chicago, IL (US)

(21) Appl. No.: 17/207,224

(22) Filed: Mar. 19, 2021

(51) Int. Cl. G01C 21/00; G06F 16/29; G01S 19/01

(52) U.S. Cl. CPC G01C 21/3819; G06F 16/29; G01S 19/01

(57) ABSTRACT

An approach is provided for route-identification from unordered line data. The approach, for example, involves receiving line data comprising a plurality of location data points representing a line or a portion of the line associated with a road link. The approach also involves calculating a heading probability and a distance probability for one or more location data points of the plurality of location data points. The heading probability is based on a deviation of a travel direction of the one or more location data points from a map link heading of a map representation of the road link, and the distance probability is based on a distance from the one or more location data points to the map representation of the road link. The approach further involves determining a map route traversed by the line data based on the heading probability and the distance probability.

### BACKGROUND

Navigation and mapping service providers are continually challenged to provide users up-to-date digital map data. One particular area of interest is the use of computer vision to enable mapping and sensing of road networks in an environment (e.g., to support autonomous or semi-autonomous operation or other location-based applications). For example, one application of vision techniques is mapping or vehicle localization with respect to known reference marks such as lane markings and/or other visible line-like environmental features. However, such lane markings or other line-like features are often sensed as unordered line data (e.g., potentially disjointed GPS points with no indication of vehicle heading). As a result, service providers face significant technical challenges to reconstruct a route or trajectory based on this unordered line data.

### SOME EXAMPLE EMBODIMENTS

Therefore, there is a need for providing route or trajectory identification for unordered line data.

According to one embodiment, a method comprises receiving line data comprising a plurality of location data points representing a line or a portion of the line associated with a road link (or any other line-like object/feature). The method also comprises calculating a heading probability and a distance probability for one or more location data points of the plurality of location data points. For example, the heading probability is based on a deviation of a travel direction of the one or more location data points from a map link heading of a map representation of the road link, and the distance probability is based on a distance from the one or more location data points to the map representation of the road link. The method further comprises determining a total probability that the one or more location data points are matched to a line representation of the map road link based on the heading probability and the distance probability. The method further comprises identifying a map route traversed by the line data based on the total probability and providing the map route as an output.

According to another embodiment, an apparatus comprises at least one processor, and at least one memory including computer program code for one or more computer programs, the at least one memory and the computer program code configured to, with the at least one processor, cause, at least in part, the apparatus to receive line data comprising a plurality of location data points representing a line or a portion of the line associated with a road link (or any other line-like object/feature). The apparatus is also caused to calculate a heading probability and a distance probability for one or more location data points of the plurality of location data points. For example, the heading probability is based on a deviation of a travel direction of the one or more location data points from a map link heading of a map representation of the road link, and the distance probability is based on a distance from the one or more location data points to the map representation of the road link. The apparatus is further caused to determine a total probability that the one or more location data points are matched to a line representation of the map road link based on the heading probability and the distance probability. The apparatus is further caused to identify a map route traversed by the line data based on the total probability and providing the map route as an output.

According to another embodiment, a computer-readable storage medium carries one or more sequences of one or more instructions which, when executed by one or more processors, cause, at least in part, an apparatus to receive line data comprising a plurality of location data points representing a line or a portion of the line associated with a road link (or any other line-like object/feature). The apparatus is also caused to calculate a heading probability and a distance probability for one or more location data points of the plurality of location data points. For example, the heading probability is based on a deviation of a travel direction of the one or more location data points from a map link heading of a map representation of the road link, and the distance probability is based on a distance from the one or more location data points to the map representation of the road link. The apparatus is further caused to determine a total probability that the one or more location data points are matched to a line representation of the map road link based on the heading probability and the distance probability. The apparatus is further caused to identify a map route traversed by the line data based on the total probability and providing the map route as an output.

According to another embodiment, an apparatus comprises means for receiving line data comprising a plurality of location data points representing a line or a portion of the line associated with a road link (or any other line-like object/feature). The apparatus also comprises means for calculating a heading probability and a distance probability for one or more location data points of the plurality of location data points. For example, the heading probability is based on a deviation of a travel direction of the one or more location data points from a map link heading of a map representation of the road link, and the distance probability is based on a distance from the one or more location data points to the map representation of the road link. The apparatus further comprises means for determining a total probability that the one or more location data points are matched to a line representation of the map road link based on the heading probability and the distance probability. The apparatus further comprises means for identifying a map route traversed by the line data based on the total probability and providing the map route as an output.

According to one embodiment, a method comprises receiving map route data that was determined based on a heading probability and a distance probability determined from line data including a plurality of location data points. In one embodiment, the heading probability is based on a deviation of a travel direction of the plurality of location data points from a map link heading of a road link of the map route data and a distance probability, and the distance probability is based on a distance from the plurality of location data points to a map representation of the road link. The method also comprises processing the map route data to perform at least one of: identifying a map error of the geographic database; localizing a vehicle; or rejecting the line data, the one or more location data points, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to receive map route data that was determined based on a heading probability and a distance probability determined from line data including a plurality of location data points. In one embodiment, the heading probability is based on a deviation of a travel direction of the plurality of location data points from a map link heading of a road link of the map route data and a distance probability, and the distance probability is based on a distance from the plurality of location data points to a map representation of the road link. The apparatus is also caused to process the map route data to perform at least one of: identifying a map error of the geographic database; localizing a vehicle; or rejecting the line data, the one or more location data points, or a combination thereof.

According to another embodiment, a computer-readable storage medium carries one or more sequences of one or more instructions which, when executed by one or more processors, cause, at least in part, an apparatus to receive map route data that was determined based on a heading probability and a distance probability determined from line data including a plurality of location data points. In one embodiment, the heading probability is based on a deviation of a travel direction of the plurality of location data points from a map link heading of a road link of the map route data and a distance probability, and the distance probability is based on a distance from the plurality of location data points to a map representation of the road link. The apparatus is also caused to process the map route data to perform at least one of: identifying a map error of the geographic database; localizing a vehicle; or rejecting the line data, the one or more location data points, or a combination thereof.

According to another embodiment, an apparatus comprises means for receiving map route data that was determined based on a heading probability and a distance probability determined from line data including a plurality of location data points. In one embodiment, the heading probability is based on a deviation of a travel direction of the plurality of location data points from a map link heading of a road link of the map route data and a distance probability, and the distance probability is based on a distance from the plurality of location data points to a map representation of the road link. The method also comprises processing the map route data to perform at least one of: identifying a map error of the geographic database; localizing a vehicle; or rejecting the line data, the one or more location data points, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing route-identification for unordered line data, according to one example embodiment;

FIGS. 2A-2C are diagrams illustrating an example of collecting line data that represent lane markings, according to one example embodiment;

FIG. 3 is a diagram of components of a mapping platform capable of providing route-identification for unordered line data, according to one example embodiment;

FIG. 4 is a flowchart of a process for providing route-identification for unordered line data, according to one example embodiment;

FIG. 5 is a diagram illustrating an example data structure for representing line data, according to one example embodiment;

FIG. 6 is a diagram illustrating example line data representing lane marking data, according to one example embodiment;

FIGS. 7A-7C are diagrams illustrating an example of calculating a heading probability for unordered line data, according to various example embodiments;

FIGS. 8A-8C are diagrams illustrating an example of calculating a distance probability for unordered line data, according to various example embodiments;

FIG. 9 is a diagram illustrating an example of route identification, according to one example embodiment;

FIG. 10 is a diagram illustrating an example output of map route data, according to one example embodiment;

FIG. 11 is a flowchart of a process for using map route data generated based on route-identification for unordered line data, according to one example embodiment;

FIG. 12 is a diagram illustrating an example of using map route data generated based on route-identification for unordered line data, according to one embodiment;

FIG. 13 is a diagram of a geographic database, according to one embodiment;

FIG. 14 is a diagram of hardware that can be used to implement an embodiment;

FIG. 15 is a diagram of a chip set that can be used to implement an embodiment; and

FIG. 16 is a diagram of a mobile terminal (e.g., handset or vehicle or part thereof) that can be used to implement an embodiment.

### DESCRIPTION OF SOME EMBODIMENTS

Examples of a method, apparatus, and computer program for providing route-identification for unordered line data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

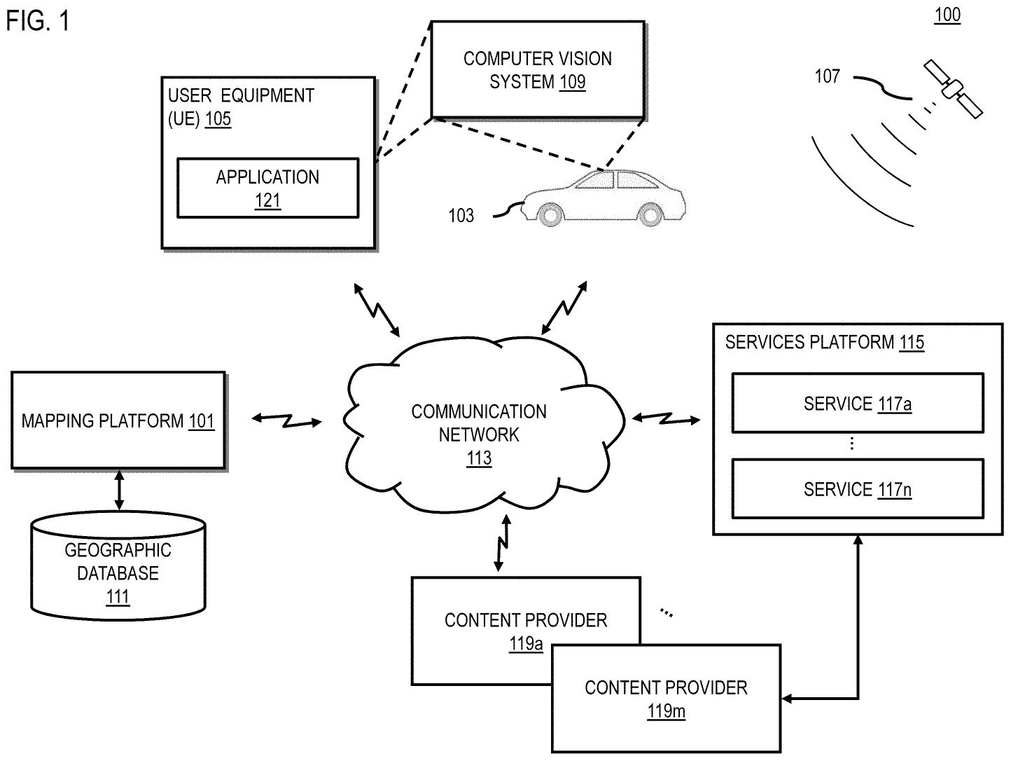

FIG. 1 is a diagram of a system capable of providing route-identification for unordered line data, according to one example embodiment. Mapping and navigation service providers (e.g., operators of a mapping platform 101) often face significant technical challenges associated with revealing or otherwise determining a route, path, or trajectory using sensor or other location line data which are constituted by two or more location data points (e.g., GPS locations or any other equivalent location data points determined using one or more sensor associated with a vehicle 103 and/or user equipment (UE) device 105 such as a satellite-based positioning system 107 or equivalent). Moreover, the sensor or other location line data is often unordered, meaning that no time sequence or order of its constituent location data points are available to determine a clear driving direction. For example, while the location of any two data points may be known, it is not known whether the direction of travel is from the first point to the second point of vice versa.

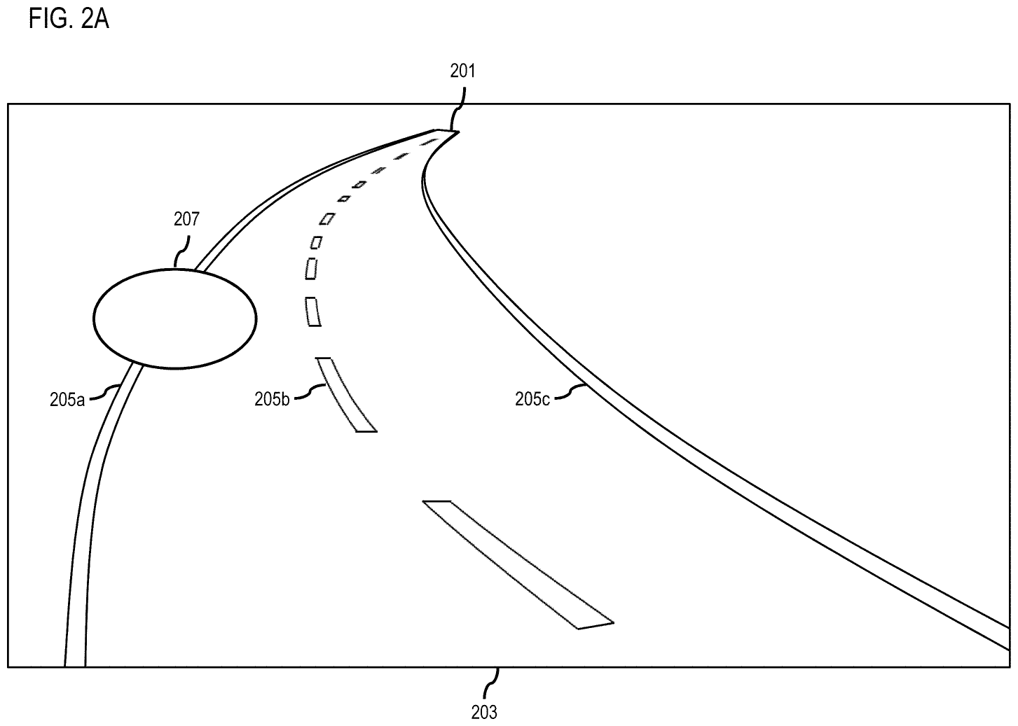

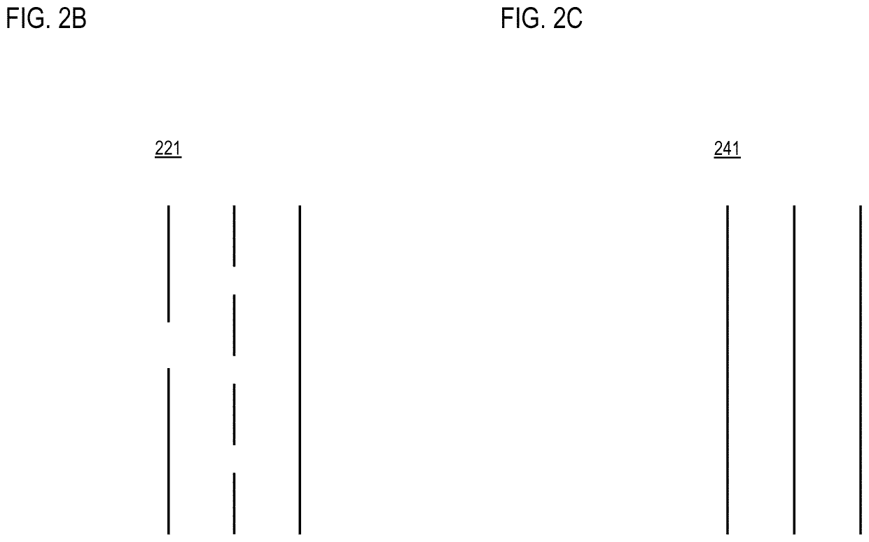

FIGS. 2A-2C are diagrams illustrating an example of collecting line data that represent lane markings, according to one example embodiment. It is noted that the lane markings of FIGS. 2A-2C are provided by way of illustration and not as limitations. Accordingly, it is contemplated that any type of line data (e.g., any type of line-based map features, shape, object, etc.) can be used according to the various embodiments described herein. As shown in FIG. 2A, a vehicle (e.g., vehicle 103) is traveling on a road 201 and captures imagery 203 of the road 201 that depicts lane markings 205a-205c. Lane markings 205a and 205c are solid lane lines marking the edges of the road 201. Lane marking 205c is a dashed line that denotes the centerline of the road 201 and divides the road 201 into two lanes.

In one embodiment, the imagery 203 can be processed (e.g., by a computer vision system 109 associated with the vehicle 103, UE 105, mapping platform 101, or any other component of the system 100 using any computer vision means known in the art) to determine GPS or other location data points (e.g., geocoordinates) representing the detected beginning and ending of lines representing the lane markings 205a-205c. However, the raw lane marking data (e.g., the aggregated line data comprising location data points indicating detected lines or line segments corresponding to detected lane markings) can be discontinuous and unordered either due to the partial occlusion (e.g., occlusion 207—such as a puddle—over lane marking 205a) or defects in the existing algorithms for lane marking detection. In the case of the centerline lane marking 205b, the dashed nature of the lane marking can result in the computer vision system 109 detecting multiple line segments instead of one continuous line.

FIG. 2B illustrates line data 221 representing the road 201 in which the line data for the left edge and centerline are discontinuous based on the raw lane marking data detected from the imagery 203 of FIG. 2A. For example, the line data 221 corresponding to the left edge is discontinuous because of the occlusion 207 has obscured a portion of the lane marking 205a from the computer vision system 109. The line data 221 corresponding to the centerline is discontinuous because the computer vision system 109 is detecting the separate dashes of the lane marking 205b as separate line segments instead of one continuous line representing the centerline of the road 201. In comparison, FIG. 2C illustrates the expected line representation 241 of the road 201 with continuous lines representing its left edge, centerline, and right edge. The expected line representation 241, for instance, corresponds to a continuous line representation (e.g., a polyline defined by a nodes/links) of map road links of the geographic database 111. These continuous map road link representations can then be used for any location-based service requiring access to map data of road networks.

As result, mapping and navigation service providers face significant technical challenges to combine the raw data (e.g., line data) with the traditional digital map data (e.g., map data of a geographic database 111) to output with continuous line representations of lane markings or any other linear features. The technical challenges can further include route identification for the unordered line data which aims at the correct map road link and travel direction for the line data.

To address these technical challenges, the system 100 of FIG. 1 introduces a capability to use a heading probability and distance probability (e.g., built on a normal distribution or equivalent) for matching location data points (e.g., GPS points or equivalent) of line data (e.g., aggregated sets of at least two location data points indicating a line) to existing map data (e.g., the geographic database 111 or equivalent). In one embodiment, the system 100 generates the heading probability based on a heading approximation determined from the location data points without needing the raw line data's heading. The system 100 generates the distance probability by matching the location data points of the line data with existing map data (e.g., a map representation of a road link—also referred to as a map road link of the map data). The heading probability and distance probability (e.g., a total probability computed as a product of the heading and distance probabilities, or other combination of the probabilities) of one or more of the location data points are matched to identify a route (e.g., a map route comprising at least one map road link) corresponding to the whole line represented in the line data.

In one embodiment, the various embodiment described herein comprise a processing pipeline built on the following:
Heading approximation and heading probability generation;
Location approximation and distance probability generation; and
Matching and route identification.

With respect to lane marking data and other equivalent discontinuous line data, the various embodiments of system 100 advantageously solves the technical problems related to the unordered features in the lane marking data to enable generation of a continuous line representation of the lane markings. Another advantage is that the various embodiments described herein utilize a probability method to estimate the best route for the lane data.

In one embodiment, the output of the system 100 (e.g., route identification or map route data determined from line data) can be widely used in location-based applications and services. Examples of these applications and services include, but is not limited to, location-based services provided over a communication network 113 by a services platform 115, one or more services 117a-117n (also collectively referred to as services 117) of the services platform 115, one or more content providers 119a-119m (also collectively referred to as content providers 119), application 121 of the UE 105, or any other component of the system 100.

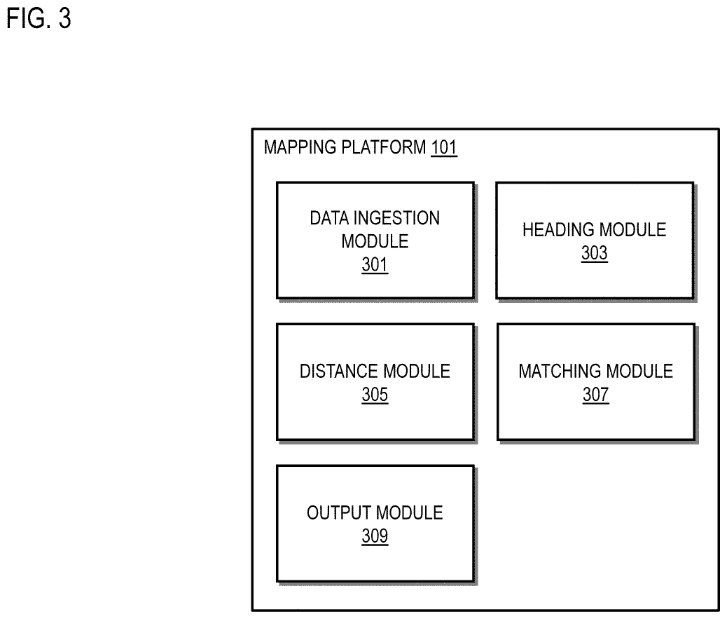

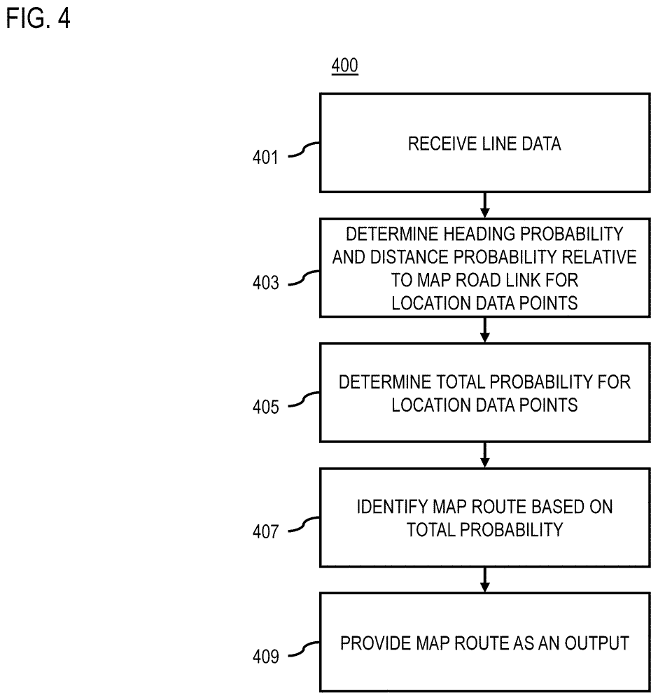

FIG. 3 is a diagram of components of a mapping platform 101 capable of providing route-identification for unordered line data, according to one example embodiment. In one embodiment, as shown in FIG. 3, the mapping platform 101 includes one or more components for processing line data according to the various embodiments described herein. As shown, in one embodiment, the mapping platform 101 includes a data ingestion module 301, a heading module 303, a distance module 305, a matching module 307, and an output module 309. The above presented modules and components of the mapping platform 101 can be implemented in hardware, firmware, software, or a combination thereof. Though depicted as a separate entity in FIG. 1, it is contemplated that the mapping platform 101 may be implemented as a module of any of the components of the system 100 (e.g., a component of the services platform 115, services 117, content providers 119, vehicle 103, UE 105, computer vision system 109, application 121, and/or the like). In another embodiment, one or more of the modules 301-309 may be implemented as a cloud-based service, local service, native application, or combination thereof. The functions of the mapping platform 101 and modules 301-309 are discussed with respect to FIGS. 4-12 below.

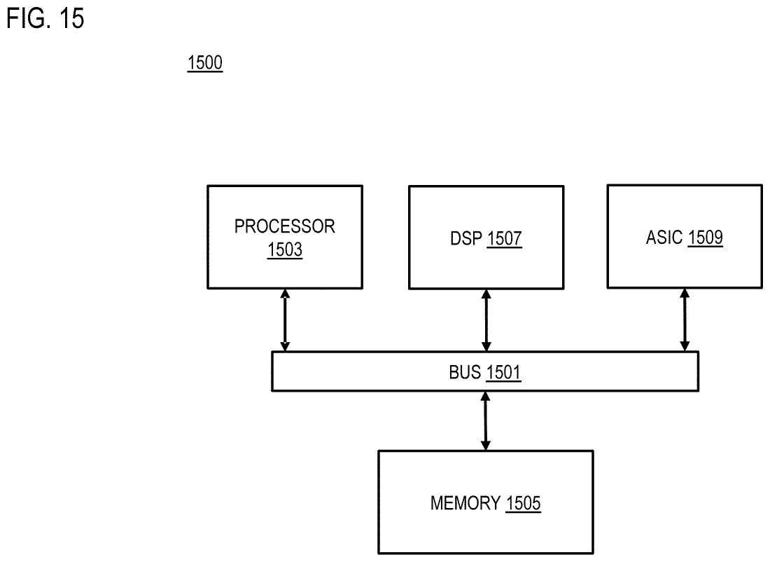

FIG. 4 is a flowchart of a process 400 for providing route-identification for unordered line data, according to one example embodiment. In various embodiments, the mapping platform 101 and/or any of the modules 301-309 may perform one or more portions of the process 400 and may be implemented in, for instance, a chip set including a processor and a memory as shown in FIG. 15. As such, the mapping platform 101 and/or any of the modules 301-309 can provide means for accomplishing various parts of the process 400, as well as means for accomplishing embodiments of other processes described herein in conjunction with other components of the system 100. Although the process 400 is illustrated and described as a sequence of steps, it is contemplated that various embodiments of the process 400 may be performed in any order or combination and need not include all of the illustrated steps.

In step 401, the data ingestion module 301 receives or otherwise determines line data comprising at least one set of location data points indicating a line. In one embodiment, the location data points are determined using a location sensor, and the line can be associated with a road link or similar linear feature (e.g., lane markings, edges, boundaries, etc.). The general data features of line data include, but is not limited to, one or more of the following:
(1) Aggregated line data are constituted by several “MultiLineString” data. Each “MultiLineString” data is constituted by two or more location data points (e.g., GPS points or equivalent) such that each “MultiLineString” data comprises a set of a plurality of location data points. A location data point, for instance, refers to a set of geocoordinates (e.g., latitude, longitude, and altitude) indicating a point location (e.g., a beginning or end point of a line or linear feature).
(2) Each “MultiLineString” data is along the corresponding road centerline but has no clear heading information.
(3) Location data points in each line data is in sequence but without clear driving or travel direction.

Based on the above general data, the line data can include location data points that are unordered (e.g., the location data points are received with no indication of a travel direction) and grouped into at least one set of location data points. Each set respectively represent a separate portion of the line (e.g., discontinuous portions of the line).

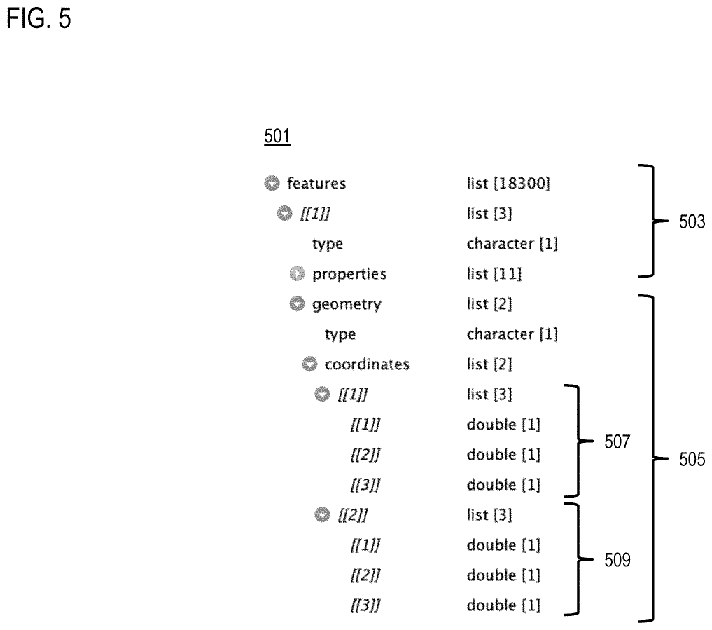

FIG. 5 is a diagram illustrating an example data structure 501 for representing line data, according to one example embodiment. The line data structure 501 can be used to represent each MultiLineString data (e.g., each set of a plurality of location data points representing a discontinuous portion of a line of interest) in the aggregated line data. In one embodiment, the line data structure 501 includes header 503 that specifies the features, feature type, and feature properties of the MultiLineString data. For example, the header 503 may indicate that the represented feature is a lane marking with related properties (e.g., bidirectionality, functional class, etc.). The line data structure 501 also includes a geometry section 505 for specifying the geometry of the represented line as at least two location data points 507 and 509). The geometry section 505 can further specify the type of geometry, and each location data point 507 and 509 can be specified by respective geocoordinate values (e.g., three values corresponding to latitude, longitude, and altitude).

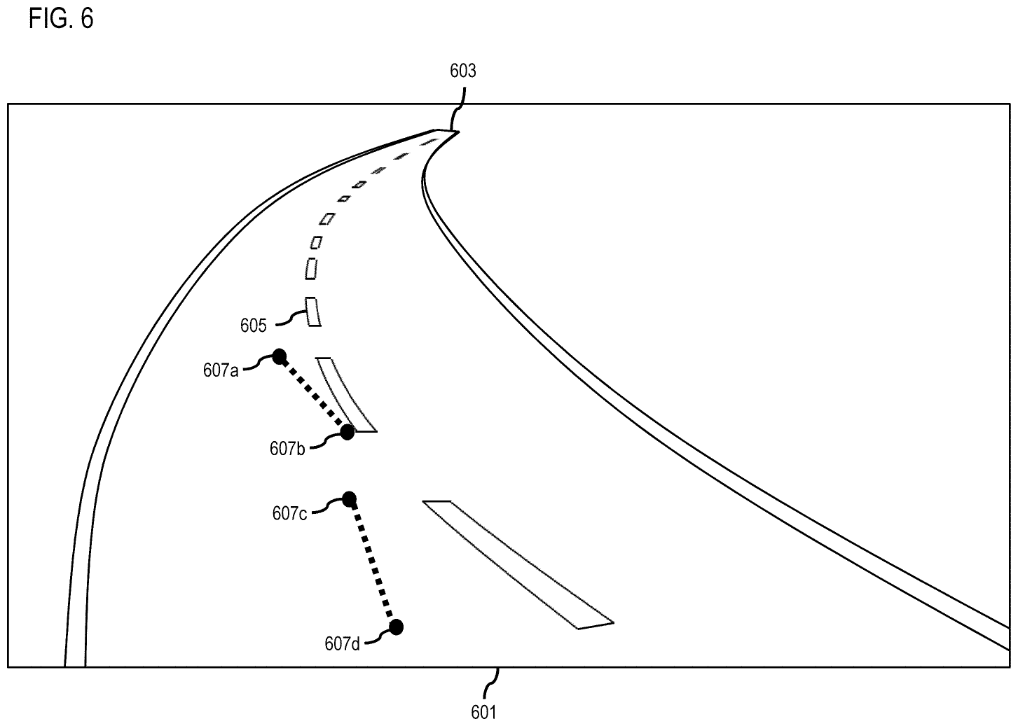

In one embodiment, the line represented in the line data is a lane marking of a road represented by a map road link (e.g., stored in the digital map data of the geographic database 111). A “map road link” refers to a map representation of a road or road segment stored as a road link data record of the geographic database 111 or equivalent digital map. FIG. 6 is a diagram illustrating example line data representing lane marking data, according to one example embodiment. In this example, vehicle imagery 601 is captured to detect and map a centerline of a road 603. The centerline of the road 603 is determined by detecting the center lane marking 605 using the computer vision system 109. The computer vision system 109, for instance, employs a neural network (e.g., a convolutional neural network) or equivalent to recognize and determine location data points corresponding to the center lane marking 605. In this example, the imagery 601 is captured in real-time by a camera system of a vehicle 103 as raster images at a predetermined pixel resolution. In one embodiment, the imagery 601 can be captured using cameras sensitive to visible light, infra-red, and/or any other wavelength of light. To support real-time operation, the imagery 601 can be part of an image stream captured at a relatively high frequency (e.g., 20 Hz, 30 Hz, or higher).

Each frame of the image stream can then be processed to provide real-time detection of lane-lines. To detect the center lane marking 605, the computer vision system 109 uses object recognition image processing to identify pixels of the image corresponding to painted surfaces of the road 603 corresponding to the dashed center lane markings. The detected positions of the beginning and ending points of dashes of the center lane markings can be determined relative to the sensed position (e.g., GPS position) of the vehicle 103 or UE 105 traveling the road 603. Because of the dashed nature of the center lane marking 605, the resulting detected line data comprises a discontinuous set of location data points 607a-607d that represent respective dashes of the center lane marking 605. In one embodiment, the location data points of the line data are provided according to the data structure 501 of FIG. 5 and does not store or provide information on the driving or travel direction of the vehicle 103 or UE 105 capturing the imagery 601, thereby backing the line data unordered with respect to travel direction. This unordered line data is an example of the line data that can be received by the data ingestion module 301 for processing according to the various embodiments described herein.

In step 403, the heading module 303 in conjunction with the distance module 305 process the received line data through a processing pipeline comprising: (1) Heading approximation and heading probability generation; and (2) location approximation and distance probability generation. In one embodiment, for each set of location data points of the received line data (e.g., each MultiLineString data in the line data), the heading module 303 and distance module 305 calculate a heading probability and a distance probability for one or more location data points of the plurality of location data points of the received line data. In one embodiment, the heading probability is based on a deviation of a travel direction of the one or more location data points from a map link heading of a map representation of the road link, and the distance probability is based on a distance from the one or more location data points to the map representation of the road link. More specifically, the heading module 303 and distance module 305 determine (1) a first heading that travels from a first point towards the second point of the location data points of the line data, a second heading that travels from the second point towards the first point, or a combination thereof; (2) a heading probability for the first point, the second point, or a combination thereof based on a deviation of the first heading, the second heading, or a combination thereof from a map link heading of a map road link of the geographic database 111; and (3) a distance probability for the first point, the second point, or a combination thereof based a distance from the first point, the second point, or a combination thereof to a line representation of the map road link.

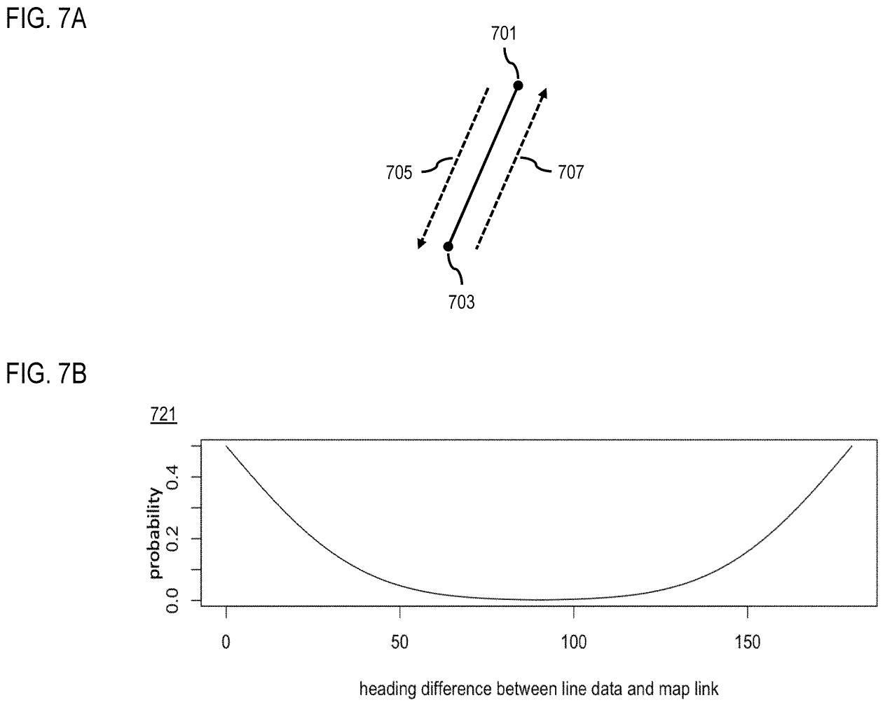

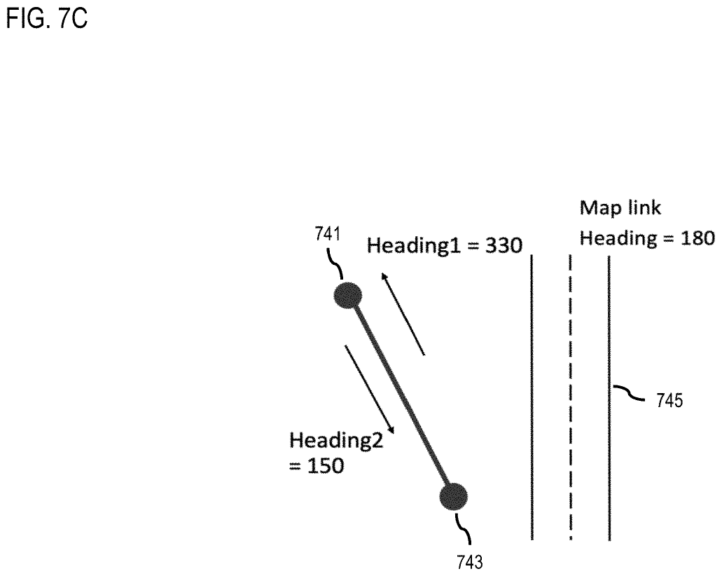

In one embodiment, for heading approximation and heading probability generation, the line data does not come with a heading or the heading provided the line data (if any) is not used. Thus, as shown in FIG. 7A, for any two points (e.g., location data point 701 and 703) in the line data, there is no information to indicate whether the driving or travel direction is from the point 701 to point 703 (e.g., heading or travel direction 705) or from point 703 to point 701 (e.g., heading or travel direction 707). Accordingly, the heading module 303 can evaluate headings which point to either side of the line (e.g., both headings 705 and 707).

In one embodiment, the heading probability measures the probability of deviation from a location data point in the line to a map road link (e.g., a closest map road link as queried from the geographic database 111). In one embodiment, the heading module 303 is configured to assume that the heading difference or deviation should follow a combined normal distribution, in which the probability of a 0° deviation and a 180° deviation should be equally high as shown in the probability distribution 721 of FIG. 7B. It is noted that the normal distribution is provided by way of illustration and not as a limitation. It is contemplated that any type of probability distribution can be used according to the embodiments described herein.

By way of example, the heading deviation (x) can be determined as the minimum deviation between the two possible headings between two location data points according to the following:

x=min(headingdiff%%180, 180−headingdiff%%180)

where x=heading deviation, and headingdiff=(heading determined from any two location data points)−(map link heading of map road link from the geographic database).

The heading probability (P(x)) indicating the probability that heading approximation x matches the determined map link heading can then be calculated as:

P(x)=2−2×Φ(x; 0, σ²)

The combined normal distribution setting solves the unordered problems in the aggregated line data. FIG. 7C is a diagram illustrating an example of heading approximation and heading probability calculation, according to one embodiment. In the example of 7C, location data points 741 and 743 are received as part of line data to evaluate. The heading module 303 computes headings in both directions for the two location data points 741 and 743. For example, Heading 1 from point 743 to point 741 is computed as 330°, and Heading 2 from point 741 to the point (e.g., in the opposite direction) is computed as 150°. The heading of a corresponding map road link against which the location data points 741 and 743 can be determined from the geographic database 111. In this example, the corresponding map road link 745 has a map link heading of 180°.

Using the equations above, the heading deviation x and heading probability P(x) for Heading 1 can be determined as follows:

Probability for Heading 1

x=min(150%%180, 180−150%%180)=30

P(x)=2−2×Φ(30; 0, 30²)=0.84

Similarly, the heading deviation x and heading probability P(x) for Heading 2 can be determined as follows:

Probability for Heading 2

x=min(30%%180, 180−30%%180)=30

P(x)=2−2×Φ(30; 0, 30²)=0.84

In one embodiment, another component of the processing pipeline is location approximation and distance probability generation to match location data points of the line data to a map road link. This component of the pipeline can be performed before, concurrently, or after the heading approximation and heading probability generation process described above. In one embodiment, location approximation can refer to any point-based map-matching process known in the art. In one embodiment, the distance module 305 assumes the point-to-line distance follows a normal distribution N(0, σ²), where σ takes the half value of lane width*lane number. However, it is noted a normal distribution is provided by way of illustration and not as a limitation. It is contemplated that any type of probability distribution for map matching location data points to a map road link can be used according to the embodiments described herein.

By way of example, under a normal distribution embodiment, the distance probability P(x) indicating the probability that a location data point is map matched to a corresponding map road link is calculated as:

P(x)=2−2*Φ(x; 0, σ²)

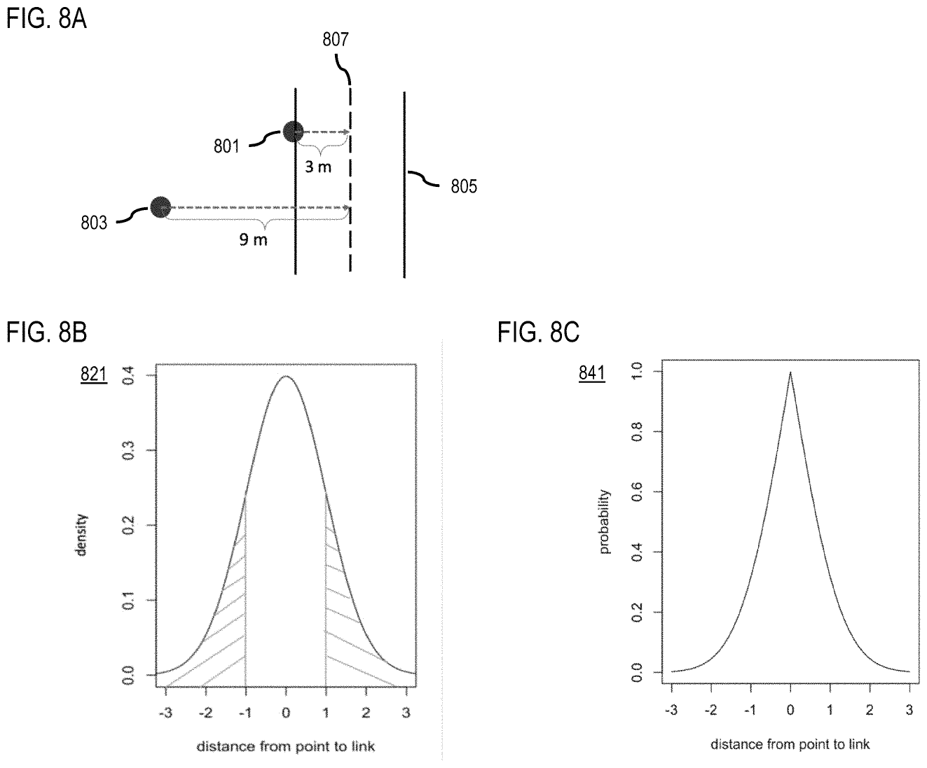

FIG. 8A is a diagram illustrating an example of determining a distance probability for location data points 801 and 803 of line data, according to one example embodiment. In this example, location data points 801 and 803 a received as part of line data that is to be evaluated according to the embodiments described herein. The distance module 305 can perform a spatial query to determine a nearest map road link 805 against which the distance probability is to be calculated. The query provides polyline representation of the map road link 805 indicating the geographic location of a centerline 807 of the map road link 805. The distance module 305 can calculate a lateral distance from each location data point 801 and 803 to the closest point on the centerline 807. In this example, the computed distance of location data point 801 to the centerline 807 is 3 meters, and the computed distance of location 803 to the centerline 807 is 9 meters. Based on this location approximation and the equation described above, the distance probability of location data points 801 and 803 can be calculated as follows:

P(location data point 801)=2(1−P(x≤3))=31.73%

P(location data point 803)=2(1−P(x≤9))=0.27%

Based on the normal distribution, the closer a location data point (e.g., GPS point) is to the map road link (e.g., centerline of the map road link), the higher the distance probability will be. For example, FIG. 8B illustrates an example density plot 821. In the density plot 821, the shaded represents the probability of match when x=1 m from the centerline. FIG. 8C illustrates a corresponding probability plot 841. In the probability plot 841, the y-axis value is the probability. When x=0 m from the centerline, the probability of match is 100%.

In one embodiment, the map road link includes one or more shape points that can help to define the shape of map road link to more closely match the corresponding real world road segment. The one or more shape points are positioned at respective points along the map road link to delineate a plurality of link segments of the map road link. Each link segment defined by the shape points can have different headings to represent different contours of the road. The one or more location data points can then be matched to respective link segments of the plurality of link segments (as opposed to matching against the entire map road link which can provide a coarser representation of the actual road). In this way, the map link heading, the line representation (e.g., centerline) of the map road link, or a combination thereof can be determined with respect based on the respective link segments for generating the heading and/or location probabilities.

In step 405, the matching module 307 calculates a total probability for at least one or more of the location data points in the line data based on the heading probability and distance probability described in the embodiments above. In other words, the matching module 307 determines or calculates a total probability that the one or more location data points are matched to map road link or a line representation (e.g., a centerline) of the map road link based on the heading probability and the distance probability. By way of example, the total probability can be determined by applying any mathematical operation or manipulation of the heading probability and the distance probability such as, but not limited to, multiplying the heading probability and the distance probability. It is contemplated that in addition to multiplying or as an alternate, the matching module 307 can use any other means to combine the heading and distance probabilities to calculate a total probability according to the embodiments described herein.

The use of a total probability or any other combination of the heading and distance probabilities indicating whether a location data point is matched to a corresponding map road link enables more specific route identification or map matching. For example, for route identification on freeways where each directional link is represented by as unique map road link (e.g., a unique LINK ID in the geographic database 111), the heading probability values for two directional links will be equal. In this case, the closer directional link will have a higher probability. Thus, the resulting total probability based on both the heading and distance probabilities will also be different.

In step 407, the matching module 307 performs route identification to determine a map route traversed by the line data based on the heading probability and the distance probability, or total probability calculated according to the embodiments described herein. For example, for a given location data point in the line data, the matching module 307 determines whether the calculated total probability (or any combination of the heading and distance probabilities) are above a threshold probability, then that location data point can be matched to the corresponding map road link or link segment thereof. In one embodiment, the map route or route identification refers to one or more map road links to which the total probability of a location data point indicates a match. If the line data spans more than map road link of the geographic database 111 the identified map route can also span the multiple road links.

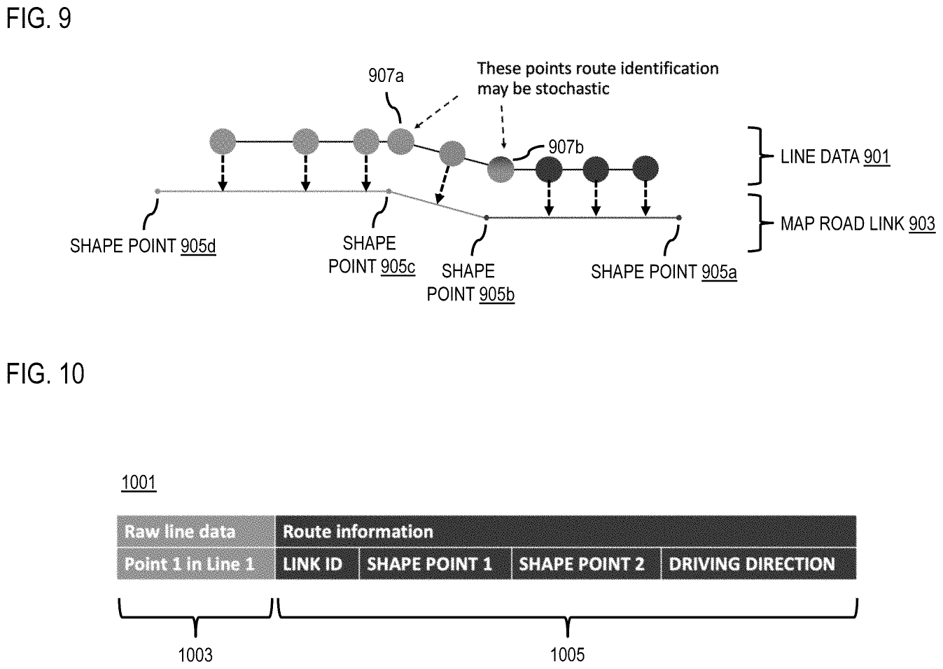

In one embodiment, the one or more location data points are matched consecutively to identify the map route or map road link. If a threshold number or percentage of the location data points of the line data meet criteria for matching (e.g., total probability is greater than a threshold probability), then the line data can be designated as matching the corresponding map road link. FIG. 9 is a diagram illustrating an example of route identification, according to one example embodiment. As shown, line data 901 includes multiple location data points (indicated by shaded circles) that are to be evaluated for matching against a map road link 903 that includes multiple shape points 905a-905d (also collectively referred as shape points 905) representing its shape. For each location data point (e.g., GPS point) in the line data, a total probability of match based on the heading and distance probabilities are computed according to the various embodiments described herein to perform route identification (e.g., map road link matching).

Each location data point whose total probability meets criteria for matching against respective link segments (e.g., defined by the respective shape points 905) of the map road link 903 are indicated by a dotted arrow pointing the matched location along the link segments. At junctions corresponding to the shape points between two adjacent link segments, the route identification of the corresponding location data points (e.g., location data points 907a and 907b) may be stochastic. However, because location points in the line data 901 are matched consecutively, not all location data points of the line data 901 need to be positively or uniquely matched to match the line data 901 to the map road link 903. As described above, a threshold percentage of the location data points can be matched to determine an overall match for the line data.

In step 409, the output module 201 provides the route identification (e.g., the map route comprising one or more map road links matched based on heading and distance probability) as an output. In one embodiment, the output pairs the one or more location data points with corresponding map information (e.g., map road link or map route comprising one or more map road links). By way of example, the map information specifies the map road link, the one or more shape points, heading information determined based on the heading probability, or a combination thereof.

FIG. 10 is a diagram illustrating an example output 1001 of map route data (e.g., map information), according to one example embodiment. As shown, the output 1001 comprises data field 1003 indicating the location data point and corresponding line data that is matched, and a data field 1005 indicating the matched route information (e.g., map road link, map route data, etc.). The route information, for instance, can include, but is not limited to, one or more of the following: (1) a matched map road link (e.g., by LINK_ID corresponding to map road link data record in the geographic database 111); (2) the two shape points delineating a matched link segment of the map road link; and (3) a driving or travel direction along the matched link segment.

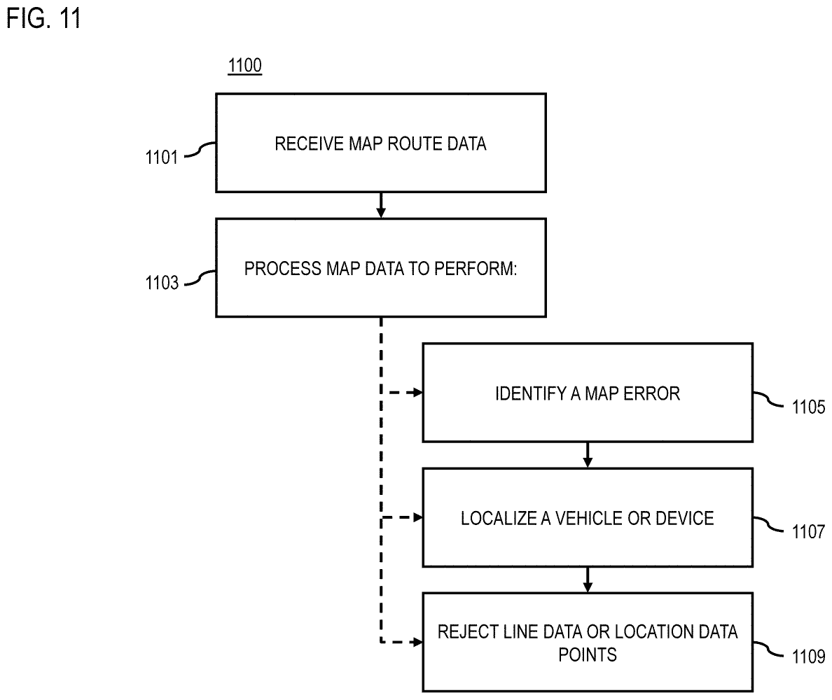

It is contemplated that the output comprising the route identification information can be provided for use by any location-based application or service to perform a corresponding function or action based on the output. Examples of these applications, services, and/or functions are provided by way of illustration with respect to FIG. 11. However, it is contemplated that any application or service using the output are applicable to the various embodiments described herein.

FIG. 11 is a flowchart of a process 1100 for using map route data generated based on route-identification for unordered line data, according to one example embodiment. In various embodiments, the mapping platform 101 and/or any of the modules 301-309 may perform one or more portions of the process 1100 and may be implemented in, for instance, a chip set including a processor and a memory as shown in FIG. 15. As such, the mapping platform 101 and/or any of the modules 301-309 can provide means for accomplishing various parts of the process 1100, as well as means for accomplishing embodiments of other processes described herein in conjunction with other components of the system 100. Although the process 1100 is illustrated and described as a sequence of steps, it is contemplated that various embodiments of the process 1100 may be performed in any order or combination and need not include all of the illustrated steps.

In step 1101, a service, application, or platform (e.g., mapping platform 101, services platform 115, services 117, content providers 119, application 121, etc.) receives map route data/route identification data that was determined based on a heading probability and a distance probability determined from line data including a plurality of location data points as described with respect to the example embodiments of the process 400 of FIG. For example, the heading probability is based on a deviation of a travel direction of the plurality of location data points from a map link heading of a road link of the map route data and a distance probability, and the distance probability is based on a distance from the plurality of location data points to a map representation of the road link.

In step 1103, service, application, or function processes the map route data/route identification to perform one or more location-based functions. In one embodiment, the function includes identifying a map error of the geographic database 111 (step 1105). In this use case, the route identification information of line data captured by a mapping vehicle (e.g., a vehicle 103 with high accuracy location sensors) is compared against existing map data of the geographic database 111 to identify potential discrepancies. For example, if the route identification includes unmatched location data points (e.g., high accuracy GPS points) that are not matched to a corresponding map road link or link segment thereof, then the map road link or link segment can be marked as having a potential map error. This potential map error can then be marked and presented by manual review, verification, additional map data collection, etc.

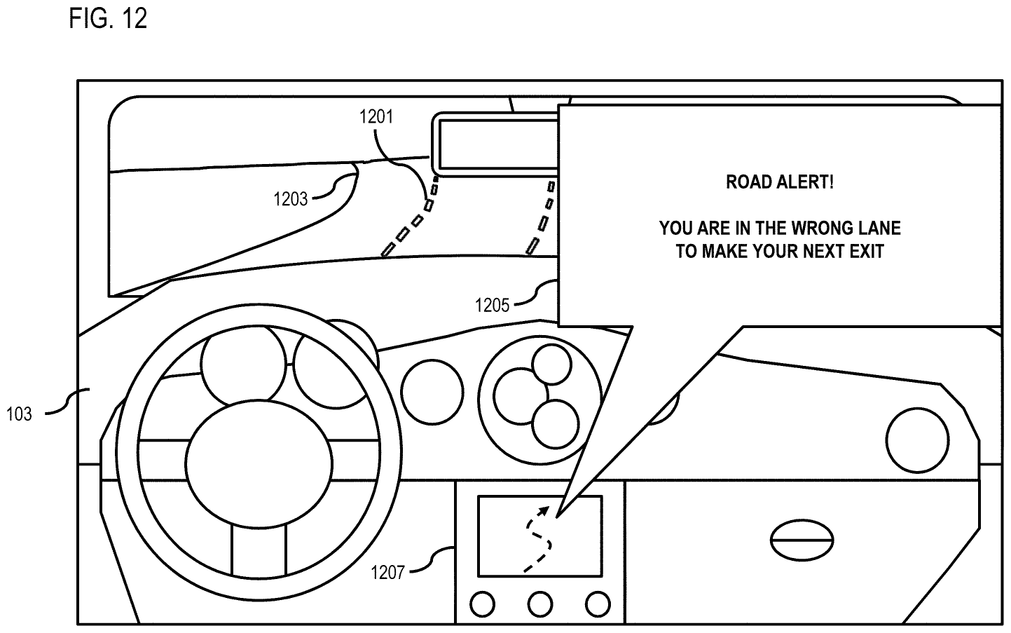

Another example use case is localizing a vehicle (step 1107) on a road. In this use case, the vehicle (e.g., vehicle 103) can use its computer vision system 109 to detect lane lines so that it can localize itself within a specific lane on a road. As shown in the example of FIG. 12, the computer vision system 109 of a vehicle 103 converts detected lane lines 1201 of a road 1203 into line data. The line data is then matched against a specific lane data of a map road link based on heading probability and distance probability discussed with respect to the embodiments described herein. Based on this matching, the vehicle 103 (e.g., via its navigation system) can determine whether the vehicle is in the correct lane to take an upcoming exit. In this example, the navigation system determines that the vehicle 103 is in the wrong lane to take the exit safely and presents an alert message 1205 stating, “Road Alert! You are in the wrong lane to make your next exit” on a user interface 1207 of the navigation system.

In another example use case, the service, application, or function can reject the line data, the one or more location data points in the line data, or a combination thereof based on the route identification output (step 1109). This use case is the opposite of the first example use case described above. In this case, the underlying map data is trusted over the collected line data. Accordingly, if the route identification data indicates that the line data does not match any map road link or link segment above a threshold probability, then the corresponding line data or location data point can be rejected or removed from further processing by the system.

As stated above, these example use cases are provided by way of illustration and not as limitations. Other examples of non-limiting examples uses cases for using the output of the process 400 include, but is not limited to, providing vehicle speed guidance, vehicle speed handling and/or control, providing a route for navigation (e.g., via a user interface), route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

Returning to FIG. 1, in one embodiment, the mapping platform 101 has connectivity over the communication network 113 to the services platform 115 that provides one or more services 117) (e.g., probe and/or sensor data collection services, and/or any other location-based/navigation services). By way of example, the services 117 may also be other third-party services and include mapping services, navigation services, traffic incident services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services platform 115 uses the output (e.g., lane-level lane departure event detection and messages) of the mapping platform 101 to provide services such as navigation, mapping, other location-based services, etc.

In one embodiment, the mapping platform 101 may be a platform with multiple interconnected components. The mapping platform 101 may include multiple servers, intelligent networking devices, computing devices, components, and corresponding software for providing parametric representations of lane lines. In addition, it is noted that the mapping platform 101 may be a separate entity of the system 100, a part of the services platform 115, a part of the one or more services 117, or included within the vehicles 103 (e.g., an embedded navigation system).

In one embodiment, content providers 119 may provide content or data (e.g., including probe data, sensor data, etc.) to the mapping platform 101, the UEs 105, the applications 121, the geographic database 111, the services platform 115, the services 117, and the vehicles 103. The content provided may be any type of content, such as map content, textual content, audio content, video content, image content, etc. In one embodiment, the content providers 119 may provide content that may aid in localizing a vehicle path or trajectory on a lane of a digital map or link. In one embodiment, the content providers 119 may also store content associated with the mapping platform 101, the geographic database 111, the services platform 115, the services 117, and/or the vehicles 103. In another embodiment, the content providers 119 may manage access to a central repository of data, and offer a consistent, standard interface to data, such as a repository of the geographic database 111.

By way of example, the UEs 105 are any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that a UE 105 can support any type of interface to the user (such as “wearable” circuitry, etc.). In one embodiment, a UE 105 may be associated with a vehicle 103 (e.g., a mobile device) or be a component part of the vehicle 103 (e.g., an embedded navigation system). In one embodiment, the UEs 105 may include the mapping platform 101 to provide lane-level mapping/routing based on route identification information determined from unordered line data.

In one embodiment, as mentioned above, the vehicles 103, for instance, are part of a probe-based system for collecting probe data and/or sensor data (e.g., comprising line data) for route identification. In one embodiment, each vehicle 103 is configured to report probe data as probe points, which are individual data records collected at a point in time that records telemetry data for that point in time. In one embodiment, the probe ID can be permanent or valid for a certain period of time. In one embodiment, the probe ID is cycled, particularly for consumer-sourced data, to protect the privacy of the source.

In one embodiment, a probe point can include attributes such as: (1) probe ID, (2) longitude, (3) latitude, and (4) altitude. The list of attributes is provided by way of illustration and not limitation. Accordingly, it is contemplated that any combination of these attributes or other attributes may be recorded as a probe point. For example, attributes such as altitude (e.g., for flight capable vehicles or for tracking non-flight vehicles in the altitude domain), tilt, steering angle, wiper activation, etc. can be included and reported for a probe point. In one embodiment, the vehicles 103 may include sensors for reporting measuring and/or reporting attributes. The attributes can also be any attribute normally collected by an on-board diagnostic (OBD) system of the vehicle 103, and available through an interface to the OBD system (e.g., OBD II interface or other similar interface).

The probe points can be reported from the vehicles 103 in real-time, in batches, continuously, or at any other frequency requested by the system 100 over, for instance, the communication network 113 for processing by the mapping platform 101. The probe points also can be map matched to specific road links stored in the geographic database 111 according to the embodiments described herein. In one embodiment, the system 100 (e.g., via the mapping platform 101) can generate probe traces (e.g., vehicle paths or trajectories) from the probe points for an individual probe so that the probe traces represent a travel trajectory or vehicle path of the probe through the road network (e.g., examples of line data).

In one embodiment, as previously stated, the vehicles 103 are configured with various sensors (e.g., vehicle sensors) for generating or collecting probe data, sensor data, related geographic/map data, etc. In one embodiment, the sensed data represents sensor data associated with a geographic location or coordinates at which the sensor data was collected. In one embodiment, the probe data (e.g., stored in the geographic database 111) includes location probes collected by one or more vehicle sensors. By way of example, the vehicle sensors may include a RADAR system, a LiDAR system, global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on a steering wheel of the vehicles 103, switch sensors for determining whether one or more vehicle switches are engaged, and the like. Though depicted as automobiles, it is contemplated the vehicles 103 can be any type of vehicle manned or unmanned (e.g., cars, trucks, buses, vans, motorcycles, scooters, drones, etc.) that travel through road segments of a road network.

Other examples of sensors of the vehicle 103 may include light sensors, orientation sensors augmented with height sensors and acceleration sensor (e.g., an accelerometer can measure acceleration and can be used to determine orientation of the vehicle), tilt sensors to detect the degree of incline or decline of the vehicle 103 along a path of travel (e.g., while on a hill or a cliff), moisture sensors, pressure sensors, etc. In a further example embodiment, sensors about the perimeter of the vehicle 103 may detect the relative distance of the vehicle 103 from a physical divider, a lane line of a link or roadway (e.g., vehicle path 201), the presence of other vehicles, pedestrians, traffic lights, potholes and any other objects, or a combination thereof. In one scenario, the vehicle sensors may detect weather data, traffic information, or a combination thereof. In one embodiment, the vehicles 103 may include GPS or other satellite-based receivers to obtain geographic coordinates from satellites 107 for determining current location and time. Further, the location can be determined by visual odometry, triangulation systems such as A-GPS, Cell of Origin, or other location extrapolation technologies.

In one embodiment, the UEs 105 may also be configured with various sensors (not shown for illustrative convenience) for acquiring and/or generating probe data and/or sensor data associated with a vehicle 103, a driver, other vehicles, conditions regarding the driving environment or roadway, etc. For example, such sensors may be used as GPS receivers for interacting with the one or more satellites 107 to determine and track the current speed, position, and location of a vehicle 103 travelling along a link or roadway. In addition, the sensors may gather tilt data (e.g., a degree of incline or decline of the vehicle during travel), motion data, light data, sound data, image data, weather data, temporal data and other data associated with the vehicles 103 and/or UEs 105. Still further, the sensors may detect local or transient network and/or wireless signals, such as those transmitted by nearby devices during navigation of a vehicle along a roadway (Li-Fi, near field communication (NFC)) etc.

It is noted therefore that the above described data may be transmitted via communication network 113 as probe data or line data (e.g., GPS point data) according to any known wireless communication protocols. For example, each UE 105, application 121, user, and/or vehicle 103 may be assigned a unique probe identifier (probe ID) for use in reporting or transmitting said probe data collected by the vehicles 103 and/or UEs 105. In one embodiment, each vehicle 103 and/or UE 105 is configured to report probe data as probe points, which are individual data records collected at a point in time that records telemetry data.

In one embodiment, the mapping platform 101 retrieves aggregated probe points gathered and/or generated by the vehicle sensors and/or the UE 105 resulting from the travel of the UEs 105 and/or vehicles 103 on a road segment of a road network. In one instance, the geographic database 111 stores a plurality of probe points and/or trajectories (e.g., line data) generated by different vehicle sensors, UEs 105, applications 121, vehicles 103, etc. over a period while traveling in a monitored area. A time sequence of probe points specifies a trajectory—i.e., a path traversed by a UE 105, application 121, vehicle 103, etc. over the period.

In one embodiment, the communication network 113 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the vehicles 103, vehicle sensors, mapping platform 101, UEs 105, applications 121, services platform 115, services 117, and/or content providers 119 communicate with each other and other components of the system 100 using well known, new or still developing protocols. In this context, a protocol includes a set of rules defining how the network nodes within the communication network 113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

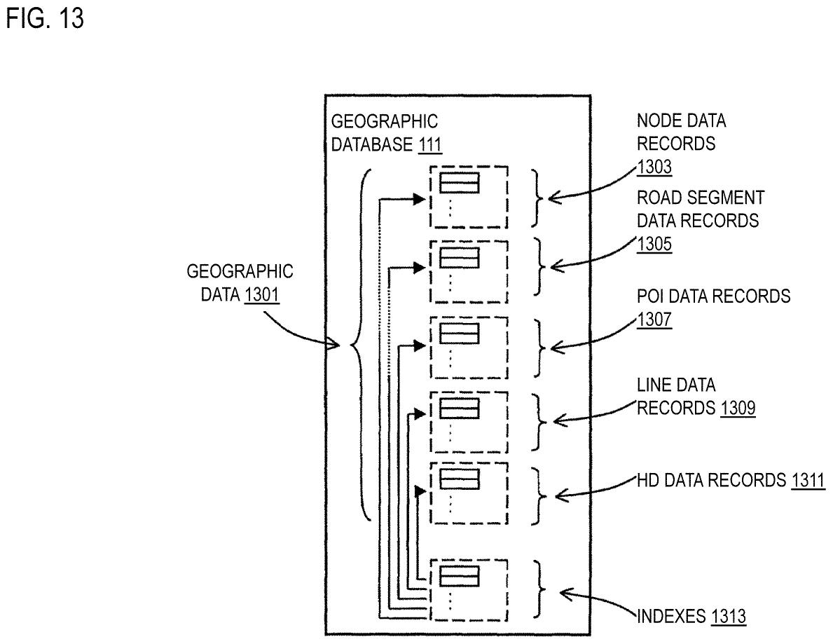

FIG. 13 is a diagram of a geographic database (such as the database 111), according to one embodiment. In one embodiment, the geographic database 111 includes geographic data 1301 used for (or configured to be compiled to be used for) mapping and/or navigation-related services, such as for video odometry based on the parametric representation of lanes include, e.g., encoding and/or decoding parametric representations into lane lines. In one embodiment, the geographic database 111 include high resolution or high definition (HD) mapping data that provide centimeter-level or better accuracy of map features. For example, the geographic database 111 can be based on Light Detection and Ranging (LiDAR) or equivalent technology to collect billions of 3D points and model road surfaces and other map features down to the number lanes and their widths. In one embodiment, the HD mapping data (e.g., HD data records 1311) capture and store details such as the slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional, or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 111.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alert a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 111 follows certain conventions. For example, links do not cross themselves and do not cross each other except at a node. Also, there are no duplicated shape points, nodes, or links. Two links that connect each other have a common node. In the geographic database 111, overlapping geographic features are represented by overlapping polygons. When polygons overlap, the boundary of one polygon crosses the boundary of the other polygon. In the geographic database 111, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 111 includes node data records 1303, road segment or link data records 1305, POI data records 1307, line data records 1309, HD mapping data records 1311, and indexes 1313, for example. More, fewer, or different data records can be provided. In one embodiment, additional data records (not shown) can include cartographic (“carto”) data records, routing data, and maneuver data. In one embodiment, the indexes 1313 may improve the speed of data retrieval operations in the geographic database 111. In one embodiment, the indexes 1313 may be used to quickly locate data without having to search every row in the geographic database 111 every time it is accessed. For example, in one embodiment, the indexes 1313 can be a spatial index of the polygon points associated with stored feature polygons.

In exemplary embodiments, the road segment data records 1305 are links or segments representing roads, streets, or paths, as can be used in the calculated route or recorded route information for determination of one or more personalized routes. The node data records 1303 are end points (such as representing intersections, respectively) corresponding to the respective links or segments of the road segment data records 1305. The road link data records 1305 and the node data records 1303 represent a road network, such as used by vehicles, cars, and/or other entities. Alternatively, the geographic database 111 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 111 can include data about the POIs and their respective locations in the POI data records 1307. The geographic database 111 can also include data about places, such as cities, towns, or other communities, and other geographic features, such as bodies of water, mountain ranges, etc. Such place or feature data can be part of the POI data records 1307 or can be associated with POIs or POI data records 1307 (such as a data point used for displaying or representing a position of a city).

In one embodiment, the geographic database 111 can also include line data records 1309 for storing the aggregated line data, route identification output data, probability information, and/or any other data generated or used by the system 100 according to the various embodiments described herein. By way of example, the line data records 1309 can be associated with one or more of the node records 1303, road segment records 1305, and/or POI data records 1307 to support traffic reporting and/or autonomous driving based on the features stored therein and the corresponding estimated quality of the features. In this way, the health data records 1309 can also be associated with or used to classify the characteristics or metadata of the corresponding records 1303, 1305, and/or 1307.

In one embodiment, as discussed above, the HD mapping data records 1311 model road surfaces and other map features to centimeter-level or better accuracy. The HD mapping data records 1311 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the HD mapping data records 1311 are divided into spatial partitions of varying sizes to provide HD mapping data to vehicles 103 and other end user devices with near real-time speed without overloading the available resources of the vehicles 103 and/or devices (e.g., computational, memory, bandwidth, etc. resources).

In one embodiment, the HD mapping data records 1311 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 1311.

In one embodiment, the HD mapping data records 1311 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 111 can be maintained by the content provider 119 in association with the services platform 115 (e.g., a map developer). The map developer can collect geographic data to generate and enhance the geographic database 111. There can be different ways used by the map developer to collect data. These ways can include obtaining data from other sources, such as municipalities or respective geographic authorities. In addition, the map developer can employ field personnel to travel by vehicle (e.g., vehicles 103 and/or UEs 105) along roads throughout the geographic region to observe features and/or record information about them, for example. Also, remote sensing, such as aerial or satellite photography, can be used.

The geographic database 111 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 103 or a UE 105, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing route identification for unordered line data may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

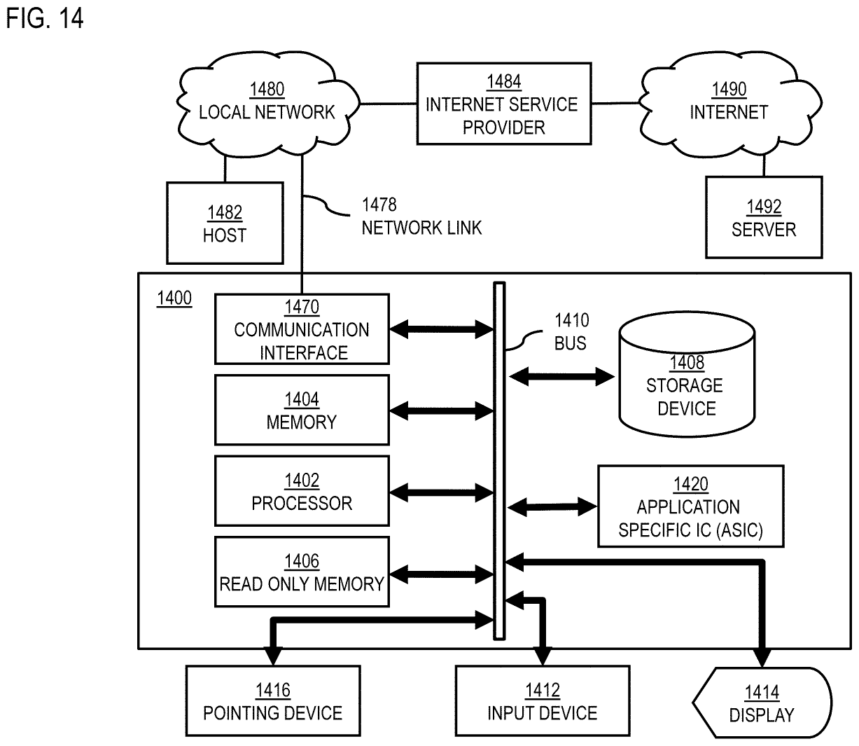

FIG. 14 illustrates a computer system 1400 upon which an embodiment of the invention may be implemented. Computer system 1400 is programmed (e.g., via computer program code or instructions) to provide route identification for unordered line data as described herein and includes a communication mechanism such as a bus 1410 for passing information between other internal and external components of the computer system 1400. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1410 includes one or more parallel conductors of information so that information is transferred quickly among devices coupled to the bus 1410. One or more processors 1402 for processing information are coupled with the bus 1410.

A processor 1402 performs a set of operations on information as specified by computer program code related to providing route identification for unordered line data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1410 and placing information on the bus 1410. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1402, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1400 also includes a memory 1404 coupled to bus 1410. The memory 1404, such as a random access memory (RAM) or other dynamic storage device, stores information including processor instructions for providing route identification for unordered line data. Dynamic memory allows information stored therein to be changed by the computer system 1400. RAM allows a unit of information stored at a location called a memory address to be stored and retrieved independently of information at neighboring addresses. The memory 1404 is also used by the processor 1402 to store temporary values during execution of processor instructions. The computer system 1400 also includes a read only memory (ROM) 1406 or other static storage device coupled to the bus 1410 for storing static information, including instructions, that is not changed by the computer system 1400. Some memory is composed of volatile storage that loses the information stored thereon when power is lost. Also coupled to bus 1410 is a non-volatile (persistent) storage device 1408, such as a magnetic disk, optical disk, or flash card, for storing information, including instructions, that persists even when the computer system 1400 is turned off or otherwise loses power.

Information, including instructions for providing route identification for unordered line data, is provided to the bus 1410 for use by the processor from an external input device 1412, such as a keyboard containing alphanumeric keys operated by a human user, or a sensor. A sensor detects conditions in its vicinity and transforms those detections into physical expression compatible with the measurable phenomenon used to represent information in computer system 1400. Other external devices coupled to bus 1410, used primarily for interacting with humans, include a display device 1414, such as a cathode ray tube (CRT) or a liquid crystal display (LCD), or plasma screen or printer for presenting text or images, and a pointing device 1416, such as a mouse or a trackball or cursor direction keys, or motion sensor, for controlling a position of a small cursor image presented on the display 1414 and issuing commands associated with graphical elements presented on the display 1414. In some embodiments, for example, in embodiments in which the computer system 1400 performs all functions automatically without human input, one or more of external input device 1412, display device 1414 and pointing device 1416 is omitted.

In the illustrated embodiment, special purpose hardware, such as an application specific integrated circuit (ASIC) 1420, is coupled to bus 1410. The special purpose hardware is configured to perform operations not performed by processor 1402 quickly enough for special purposes. Examples of application specific ICs include graphics accelerator cards for generating images for display 1414, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1400 also includes one or more instances of a communications interface 1470 coupled to bus 1410. Communication interface 1470 provides a one-way or two-way communication coupling to a variety of external devices that operate with their own processors, such as printers, scanners, and external disks. In general, the coupling is with a network link 1478 that is connected to a local network 1480 to which a variety of external devices with their own processors are connected. For example, communication interface 1470 may be a parallel port or a serial port or a universal serial bus (USB) port on a personal computer. In some embodiments, communications interface 1470 is an integrated services digital network (ISDN) card or a digital subscriber line (DSL) card or a telephone modem that provides an information communication connection to a corresponding type of telephone line. In some embodiments, a communication interface 1470 is a cable modem that converts signals on bus 1410 into signals for a communication connection over a coaxial cable or into optical signals for a communication connection over a fiber optic cable. As another example, communications interface 1470 may be a local area network (LAN) card to provide a data communication connection to a compatible LAN, such as Ethernet. Wireless links may also be implemented. For wireless links, the communications interface 1470 sends or receives or both sends and receives electrical, acoustic, or electromagnetic signals, including infrared and optical signals, that carry information streams, such as digital data. For example, in wireless handheld devices, such as mobile telephones like cell phones, the communications interface 1470 includes a radio band electromagnetic transmitter and receiver called a radio transceiver. In certain embodiments, the communications interface 1470 enables connection to the communication network 113 for providing route identification for unordered line data to the vehicle 103 and/or the UE 105.

The term computer-readable medium is used herein to refer to any medium that participates in providing information to processor 1402, including instructions for execution. Such a medium may take many forms, including, but not limited to, non-volatile media, volatile media, and transmission media. Non-volatile media include, for example, optical or magnetic disks, such as storage device 1408. Volatile media include, for example, dynamic memory 1404. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1478 typically provides information communication using transmission media through one or more networks to other devices that use or process the information. For example, network link 1478 may provide a connection through local network 1480 to a host computer 1482 or to equipment 1484 operated by an Internet Service Provider (ISP). ISP equipment 1484 in turn provides data communication services through the public, world-wide packet-switching communication network of networks now commonly referred to as the Internet 1490.

A computer called a server host 1492 connected to the Internet hosts a process that provides a service in response to information received over the Internet. For example, server host 1492 hosts a process that provides information representing video data for presentation at display 1414. It is contemplated that the components of system can be deployed in various configurations within other computer systems, e.g., host 1482 and server 1492.

FIG. 15 illustrates a chip set 1500 upon which an embodiment of the invention may be implemented. Chip set 1500 is programmed to provide route identification for unordered line data as described herein and includes, for instance, the processor and memory components described with respect to FIG. 14 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1500 includes a communication mechanism such as a bus 1501 for passing information among the components of the chip set 1500. A processor 1503 has connectivity to the bus 1501 to execute instructions and process information stored in, for example, a memory 1505. The processor 1503 may include one or more processing cores with each core configured to perform independently. A multi-core processor enables multiprocessing within a single physical package. Examples of a multi-core processor include two, four, eight, or greater numbers of processing cores. Alternatively or in addition, the processor 1503 may include one or more microprocessors configured in tandem via the bus 1501 to enable independent execution of instructions, pipelining, and multithreading. The processor 1503 may also be accompanied with one or more specialized components to perform certain processing functions and tasks such as one or more digital signal processors (DSP) 1507, or one or more application-specific integrated circuits (ASIC) 1509. A DSP 1507 typically is configured to process real-world signals (e.g., sound) in real time independently of the processor 1503. Similarly, an ASIC 1509 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1503 and accompanying components have connectivity to the memory 1505 via the bus 1501. The memory 1505 includes both dynamic memory (e.g., RAM, magnetic disk, writable optical disk, etc.) and static memory (e.g., ROM, CD-ROM, etc.) for storing executable instructions that when executed perform the inventive steps described herein to provide route identification for unordered line data. The memory 1505 also stores the data associated with or generated by the execution of the inventive steps.

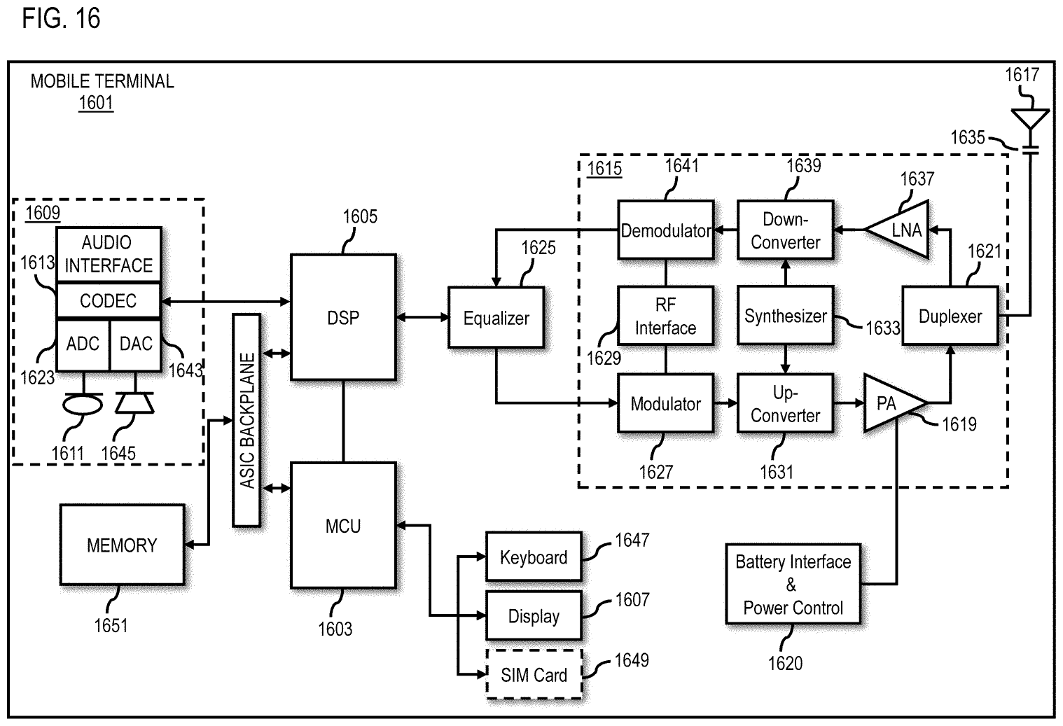

FIG. 16 is a diagram of exemplary components of a mobile terminal 1601 (e.g., UE 105, vehicle 103, or a part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1603, a Digital Signal Processor (DSP) 1605, and a receiver/transmitter unit including a microphone gain control unit and a speaker gain control unit. A main display unit 1607 provides a display to the user in support of various applications and mobile station functions that offer automatic contact matching. An audio function circuitry 1609 includes a microphone 1611 and microphone amplifier that amplifies the speech signal output from the microphone 1611. The amplified speech signal output from the microphone 1611 is fed to a coder/decoder (CODEC) 1613.

A radio section 1615 amplifies power and converts frequency in order to communicate with a base station, which is included in a mobile communication system, via antenna 1617. The power amplifier (PA) 1619 and the transmitter/modulation circuitry are operationally responsive to the MCU 1603, with an output from the PA 1619 coupled to the duplexer 1621 or circulator or antenna switch, as known in the art. The PA 1619 also couples to a battery interface and power control unit 1620.

In use, a user of mobile station 1601 speaks into the microphone 1611 and his or her voice along with any detected background noise is converted into an analog voltage. The analog voltage is then converted into a digital signal through the Analog to Digital Converter (ADC) 1623. The control unit 1603 routes the digital signal into the DSP 1605 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1625 for compensation of any frequency-dependent impairments that occur during transmission though the air such as phase and amplitude distortion. After equalizing the bit stream, the modulator 1627 combines the signal with a RF signal generated in the RF interface 1629. The modulator 1627 generates a sine wave by way of frequency or phase modulation. In order to prepare the signal for transmission, an up-converter 1631 combines the sine wave output from the modulator 1627 with another sine wave generated by a synthesizer 1633 to achieve the desired frequency of transmission. The signal is then sent through a PA 1619 to increase the signal to an appropriate power level. In practical systems, the PA 1619 acts as a variable gain amplifier whose gain is controlled by the DSP 1605 from information received from a network base station. The signal is then filtered within the duplexer 1621 and optionally sent to an antenna coupler 1635 to match impedances to provide maximum power transfer. Finally, the signal is transmitted via antenna 1617 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1601 are received via antenna 1617 and immediately amplified by a low noise amplifier (LNA) 1637. A down-converter 1639 lowers the carrier frequency while the demodulator 1641 strips away the RF leaving only a digital bit stream. The signal then goes through the equalizer 1625 and is processed by the DSP 1605. A Digital to Analog Converter (DAC) 1643 converts the signal and the resulting output is transmitted to the user through the speaker 1645, all under control of a Main Control Unit (MCU) 1603—which can be implemented as a Central Processing Unit (CPU) (not shown).

The MCU 1603 receives various signals including input signals from the keyboard 1647. The keyboard 1647 and/or the MCU 1603 in combination with other user input components (e.g., the microphone 1611) comprise a user interface circuitry for managing user input. The MCU 1603 runs a user interface software to facilitate user control of at least some functions of the mobile station 1601 to provide route identification for unordered line data. The MCU 1603 also delivers a display command and a switch command to the display 1607 and to the speech output switching controller, respectively. Further, the MCU 1603 exchanges information with the DSP 1605 and can access an optionally incorporated SIM card 1649 and a memory 1651. In addition, the MCU 1603 executes various control functions required of the station. The DSP 1605 may, depending upon the implementation, perform any of a variety of conventional digital processing functions on the voice signals. Additionally, DSP 1605 determines the background noise level of the local environment from the signals detected by microphone 1611 and sets the gain of microphone 1611 to a level selected to compensate for the natural tendency of the user of the mobile station 1601.

The CODEC 1613 includes the ADC 1623 and DAC 1643. The memory 1651 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1651 may be, but not limited to, a single memory, CD, DVD, ROM, RAM, EEPROM, optical storage, or any other non-volatile or non-transitory storage medium capable of storing digital data.

An optionally incorporated SIM card 1649 carries, for instance, important information, such as the cellular phone number, the carrier supplying service, subscription details, and security information. The SIM card 1649 serves primarily to identify the mobile station 1601 on a radio network. The card 1649 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving line data comprising at least one set of location data points indicating a line, wherein the location data points are determined using a location sensor;
for each set of the at least one set, determining (1) a first heading that travels from a first point towards the second point of the location data points, a second heading that travels from the second point towards the first point, or a combination thereof; (2) a heading probability for the first point, the second point, or a combination thereof based on a deviation of the first heading, the second heading, or a combination thereof from a map link heading of a map road link of a geographic database; and (3) a distance probability for the first point, the second point, or a combination thereof based on a distance from the first point, the second point, or a combination thereof to a line representation of the map road link;
determining a total probability that the one or more location data points are matched to the line representation of the map road link based on the heading probability and the distance probability;
identifying a map route traversed by the line data based on the total probability; and
providing the map route as an output.

2. The method of claim 1, wherein the location data points are unordered and said each set of the least one set respectively represent a separate portion of the line.

3. The method of claim 1, wherein the map road link includes one or more shape points, and wherein the one or more shape points delineate a plurality of link segments of the map road link.

4. The method of claim 3, wherein the one or more location data points are matched to respective link segments of the plurality of link segments; and wherein the map link heading, the line representation of the map road link, or a combination thereof is determined with respect based on the respective link segments.

5. The method of claim 3, wherein the output pairs the one or more location data points with corresponding map information; and wherein the map information specifies the map road link, the one or more shape points, heading information determined based on the heading probability, or a combination thereof.

6. The method of claim 1, wherein the total probability is determined by applying a mathematical operation on the heading probability and the distance probability.

7. The method of claim 1, wherein the location data points are received with no indication of a travel direction.

8. The method of claim 1, wherein the one or more location data points are matched consecutively to identify the map route.

9. The method of claim 1, wherein the line is a lane marking of a road represented by the map road link.

10. The method of claim 1, further comprising:
identifying a map error of the geographic database based on the output.

11. The method of claim 1, further comprising:
performing a localization of a vehicle based on the output.

12. The method of claim 1, further comprising:
rejecting the line data, the one or more location data points, or a combination thereof based on the output.

13. An apparatus comprising:
at least one processor; and
at least one memory including computer program code for one or more programs,
the at least one memory and the computer program code configured to, with the at least one processor, cause the apparatus to perform at least the following,
receive line data comprising a plurality of location data points representing a line or a portion of the line associated with a road link;
calculate a heading probability and a distance probability for one or more location data points of the plurality of location data points, wherein the heading probability is based on a deviation of a travel direction of the one or more location data points from a map link heading of a map representation of the road link, and wherein the distance probability is based on a distance from the one or more location data points to the map representation of the road link; and
determine a map route traversed by the line data based on the heading probability and the distance probability.

14. The apparatus of claim 13, wherein the apparatus is further caused to:
identify a map error of the geographic database based on the output.

15. The apparatus of claim 13, wherein the apparatus is further caused to:
perform a localization of a vehicle based on the output.

16. The apparatus of claim 13, wherein the apparatus is further caused to:
reject the line data, the one or more location data points, or a combination thereof based on the output.

17. A non-transitory computer-readable storage medium, carrying one or more sequences of one or more instructions which, when executed by one or more processors, cause an apparatus to at least perform the following steps:
receiving map route data that was determined based on a heading probability and a distance probability determined from line data including a plurality of location data points, wherein the heading probability is based on a deviation of a travel direction of the plurality of location data points from a map link heading of a road link of the map route data and a distance probability, and wherein the distance probability is based on a distance from the plurality of location data points to a map representation of the road link; and
processing the map route data to perform at least one of:
identifying a map error of the geographic database;
localizing a vehicle; or
rejecting the line data, the one or more location data points, or a combination thereof.

18. The non-transitory computer-readable storage medium of claim 17, wherein the location data points are unordered and said each set of the least one set respectively represent a separate portion of the line.

19. The non-transitory computer-readable storage medium of claim 17, wherein the map representation includes one or more shape points, and wherein the one or more shape points delineate a plurality of link segments of the map representation.

20. The non-transitory computer-readable storage medium of claim 19, wherein the one or more location data points are matched to respective link segments of the plurality of link segments; and wherein the map link heading, the centerline of the map representation, or a combination thereof is determined with respect based on the respective link segments.
